(19) United States
(12) Patent Application Publication
(10) Pub. No.: US 2010/0094746 A1
(43) Pub. Date: Apr. 15, 2010

(54) SYSTEM AND METHOD FOR AGGREGATION OF IMPLIED SHORT TERM INTEREST RATE DERIVATIVES BIDS AND OFFERS

(75) Inventors: Paul MacGregor, London (GB); John Patrick O'Neill, London (GB); Gary David Hooper, London (GB)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: NYSE LIFFE Administration and Management, London (GB)

(21) Appl. No.: 12/571,972

(22) Filed: Oct. 1, 2009

Related U.S. Application Data
(63) Continuation-in-part of application No. 11/260,492, filed on Oct. 28, 2005.

(51) Int. Cl. G06Q 40/00

(52) U.S. Cl. 705/37

(57) ABSTRACT

A method and system for facilitating trading of derivatives contracts is provided. The method includes receiving orders, including bids and/or offers, and creating implied orders for matching combinations of outright and strategy orders based on permitted implied patterns.

### CROSS REFERENCE TO RELATED APPLICATIONS

This application is a continuation-in-part of and claims priority benefit of U.S. patent application Ser. No. 11/260,492, filed Oct. 28, 2005, the contents of which are incorporated herein by reference in their entirety.

### BACKGROUND OF THE INVENTION

1. Field of the Invention

The present invention relates to the field of financial markets. More particularly, the invention relates to the trading of financial instruments which have multiple maturity months, stretching out several years, such as the Euribor futures market, the Euribor Options market, the Eurodollar futures market, the Eurodollar Options market, the Short Sterling futures market, and the Short Sterling Options market.

2. Related Art

Volatility and uncertainty are ever present in today's financial markets, not least in the interest rate markets. In the face of this type of uncertainty, treasurers and fund managers are increasingly advised to consider methods of managing their exposure to sharp movements in the financial markets. Short Term Interest Rate (STIR) futures and options can provide the flexibility and security required.

Treasurers, fund managers and other market participants have a number of choices available to them to help them manage their interest rate exposure. This may be accomplished either by using exchange-traded products, like futures and options contracts, or over-the-counter (OTC) products, such as swaps, Forward Rate Agreements (FRAs), caps, and floors, together with the underlying cash markets themselves. Indeed, successful players in today's volatile markets typically employ the full range of available risk management and trading strategies.

Exchange-traded futures and options contracts offer market participants not only a high degree of versatility in their use, but also significant advantages as strategic instruments, especially when complemented by OTC derivative and cash market financial instruments. Indeed, when used effectively, exchange-traded futures and options contracts, sometimes in conjunction with cash market and OTC derivative instruments, can enhance returns, reduce risks and manage interest rate risks with greater certainty, precision and economy.

A derivative financial product refers to any financial product that derives from another financial product, usually (but not always) the underlying cash markets. STIR futures, as derivative products, derive from the underlying cash money markets.

A futures contract is a legally binding agreement, concerned with the buying, or selling, of a standardized product, at a fixed price, for cash settlement or physical delivery on a given future date. In the case of STIR futures, the standardized product is short-term interest rates. STIR futures contracts derive from the cash inter-bank markets, and are concerned with trading the value of three-month LIBOR (£ and CHF), Euribor ( [symbol] ), Eurodollar ($) or TIBOR (Yen). Currently, for example, NYSE Liffe makes the following STIR futures available for trading, as shown below in Table 1:

TABLE 1
STIR Futures Contracts Specifications on NYSE Liffe

| | Euroswiss | Eurodollar | Euribor | Euroyen | Short Sterling |
|---|---|---|---|---|---|
| Unit of Trading | SFr1m | US$1m | [symbol] 1m | Euroyen100m | £500,000 |
| Delivery Months | March, June, September, December (plus serial) | | | | |
| Last Trading Day | Two business days prior to third Wednesday | | | | Third Wed |
| Quotation | 100.00 minus rate of interest | | | | |
| Price Movement | 0.01 | 0.005 | 0.005 | 0.005 | 0.01 |
| (Value) | SFr 25 | $12.50 | [symbol] 12.50 | ¥1250 | £12.50 |

A trader enters an order into an electronic STIR futures market by entering a “bid” (i.e., an intention to buy) or an “offer” (i.e., an intention to sell) into the system. When prices for bids and offers are matched, a trade confirmation is generated by the electronic trading platform. Users of the system may enter bids or offers into individual contract months, or directly into the strategy markets, as defined below. At the end of trading, the exchange publishes a settlement price for each individual contract month on each STIR product. Settlement prices are defined by the exchange, and take into account the prices at which trades are occurring, and the relative weight of bids and offers in the marketplace. A futures contract has a settlement price, every day at the end of trading, but the final settlement price on the Last Trading Day when the contract expires, is known as the Exchange Delivery Settlement Price (EDSP).

Futures and options can be used for three main purposes: hedging, speculating, and arbitraging. A hedger uses the market to offset, cover, or protect, either an actual underlying position, or a perceived requirement. A true hedger therefore, does not seek to profit from a hedge, but simply takes a position as a form of insurance, to cover a position in one market, or product, with an equal and opposite position in another. A “perfect hedge” should therefore result in a profit in one position being fully offset by an equal and opposite loss in the other. In general, protection against a fall in interest rates can be achieved by buying futures; i.e., a so-called “long” hedge. Protection against a rise in interest rates can be achieved by selling futures, i.e., a so-called “short” hedge.

A speculator uses the STIR market to simply “buy low” and “sell high” or vice versa, thereby hoping to make a profit from the difference in price. A speculator therefore has no real need of the underlying product concerned and can speculate on any contract. However, speculators perform the useful purpose of providing much needed liquidity (i.e., a plurality of buyers and sellers at any given price) to any futures contract.

Products that have identical characteristics and so are perfect substitutes for each other should theoretically trade at the same price. If they do not, a risk-free profit can be obtained by simultaneously selling the higher-priced one and buying the lower-priced one. An “arbitrageur” is therefore someone who uses the markets to take advantage of pricing anomalies that may occur. Such an anomaly could occur between two inter-related products on an exchange, or between two inter-related products on two different exchanges, or between an exchange-traded product and the same product trading in the OTC market. Importantly, with respect to arbitrage, it can only be defined as “pure” arbitrage if both sides of the transaction are dealt simultaneously (i.e., there is no risk at any time). Any delay involved, such as, for example, waiting for one side to move more than the other, is known in the markets as “legging risk” or “lifting a leg”. These delay scenarios are not pure arbitrage, because an element of risk has thereby been introduced.

### SUMMARY OF THE INVENTION

In one aspect, the invention provides a method of facilitating trades relating to futures contracts. The method comprises the steps of: receiving a plurality of orders, each of the plurality of orders being selected from the group consisting of a bid for an outright month futures contract, a bid for a predetermined combination of outright month futures contracts known as a futures strategy, an offer for an outright month futures contract, and an offer for a futures strategy; using a computer to match corresponding orders from within the received plurality of orders; and using a computer to electronically execute trades corresponding to the matched orders.

The method may further include the step of combining at least two orders selected from the group consisting of a bid for an outright month futures contract and an offer for an outright month futures contract to form an implied combination order. The step of using a computer to match may further include using a computer to match the combination order with at least one order selected from the group consisting of a bid for a futures strategy and an offer for a futures strategy. Alternatively, the method may further include the step of combining at least one order selected from the group consisting of a bid for an outright month futures contract and an offer for an outright month futures contract with at least one order selected from the group consisting of a bid for a futures strategy and an offer for a futures strategy to form a combination order, and the step of using a computer to match may further include using a computer to match the combination order with at least one order selected from the group consisting of a bid for an outright month futures contract and an offer for an outright month futures contract.

In another alternative, the method may further include the step of combining at least two orders selected from the group consisting of a bid for a futures strategy and an offer for a futures strategy to form a combination order, and the step of using a computer to match may further include using a computer to match the combination order with at least one order selected from the group consisting of a bid for a futures strategy and an offer for a futures strategy. In yet another alternative, the method may further include the step of combining at least one order selected from the group consisting of a bid for an outright month futures contract and an offer for an outright month futures contract with at least one order selected from the group consisting of a bid for a futures strategy and an offer for a futures strategy to form a combination order, and the step of using a computer to match may further include using a computer to match the combination order with at least one order selected from the group consisting of a bid for a futures strategy and an offer for a futures strategy. The step of using a computer to match may further include using a computer to match at least a first order and a second order for which a sum of leg ratios of all constituent outright month futures contracts is equal to zero. The method may further comprise the step of receiving a list of supported types of combinations provided by an operator, wherein the step of using a computer to match further comprises the step of using a computer to match corresponding orders from within the received plurality of orders such that the matched orders form a combination that is included on the list of supported types of combinations.

In another aspect, the invention provides a system for facilitating trading of futures contracts. The system comprises a server at which the futures contracts are actively traded; and an interface in communication with the server, the interface being configured to enable at least order for a futures contract to be entered. The server is configured to receive a plurality of orders via the interface, each order including a price and a number of lots. Each of the plurality of orders is selected from the group consisting of a bid for an outright month futures contract, a bid for a predetermined combination of outright month futures contracts known as a futures strategy, an offer for an outright month futures contract, and an offer for a futures strategy. The server is further configured to match corresponding orders from within the received plurality of orders, and to electronically execute trades corresponding to the matched orders.

The server may be further configured to combine at least two orders selected from the group consisting of a bid for an outright month futures contract and an offer for an outright month futures contract to form a combination order, and to match the combination order with at least one order selected from the group consisting of a bid for a futures strategy and an offer for a futures strategy. Alternatively, the server may be further configured to combine at least one order selected from the group consisting of a bid for an outright month futures contract and an offer for an outright month futures contract with at least one order selected from the group consisting of a bid for a futures strategy and an offer for a futures strategy to form a combination order, and to match the combination order with at least one order selected from the group consisting of a bid for an outright month futures contract and an offer for an outright month futures contract.

In another alternative, the server may be further configured to combine at least two orders selected from the group consisting of a bid for a futures strategy and an offer for a futures strategy to form a combination order, and to match the combination order with at least one order selected from the group consisting of a bid for a futures strategy and an offer for a futures strategy contract. In yet another alternative, the server may be further configured to combine at least one order selected from the group consisting of a bid for an outright month futures contract and an offer for an outright month futures contract with at least one order selected from the group consisting of a bid for a futures strategy and an offer for a futures strategy to form a combination order, and to match the combination order with at least one order selected from the group consisting of a bid for a futures strategy and an offer for a futures strategy. The server may be further configured to match at least a first order and a second order for which a sum of leg ratios of all constituent outright month futures contracts is equal to zero. The server may be further configured to receive a list of supported types of combinations provided by an operator, and to match corresponding orders from within the received plurality of orders such that the matched orders form a combination that is included on the list of supported types of combinations.

### BRIEF DESCRIPTION OF THE DRAWINGS

FIG. 1 illustrates a block diagram of a system for facilitating trading of STIR futures according to a preferred embodiment of the invention.

FIG. 2 is a flow chart that illustrates a method of facilitating trading of STIR futures according to a preferred embodiment of the invention.

FIG. 3 is a block diagram that illustrates aggregation of implied orders according to a preferred embodiment of the invention.

FIG. 4 is a pair of flow diagrams that illustrate a first implied-in route from a calendar spread and outright months into a butterfly, according to a preferred embodiment of the invention.

FIG. 5 is a pair of flow diagrams that illustrate a second implied-in route from a calendar spread and outright months into a butterfly, according to a preferred embodiment of the invention.

FIG. 6 is a pair of flow diagrams that illustrate an implied-in route from two calendar spreads into a butterfly, according to a preferred embodiment of the invention.

FIG. 7 is a pair of flow diagrams that illustrate a first implied-in route from a butterfly and a calendar spread into a calendar spread, according to a preferred embodiment of the invention.

FIG. 8 is a pair of flow diagrams that illustrate a second implied-in route from a butterfly and a calendar spread into a calendar spread, according to a preferred embodiment of the invention.

FIG. 9 is a pair of flow diagrams that illustrate an implied-in route from a butterfly and two outright months into a calendar spread, according to a preferred embodiment of the invention.

FIG. 10 is a pair of flow diagrams that illustrate an implied-out route from a butterfly and outright months into an outright front leg of a butterfly, according to a preferred embodiment of the invention.

FIG. 11 is a pair of flow diagrams that illustrate an implied-out route from a butterfly and outright months into an outright middle leg of a butterfly, according to a preferred embodiment of the invention.

FIG. 12 is a pair of flow diagrams that illustrate an implied-out route from a butterfly and outright months into a outright back leg of a butterfly, according to a preferred embodiment of the invention.

FIG. 13 is a pair of flow diagrams that illustrate a first implied-out route from a butterfly, a calendar spread, and an outright month into a outright front leg of butterfly, according to a preferred embodiment of the invention.

FIG. 14 is a pair of flow diagrams that illustrate a first implied-out route from a butterfly, a calendar spread, and an outright month into a outright back leg of butterfly, according to a preferred embodiment of the invention.

FIG. 15 is a pair of flow diagrams that illustrate a first implied-out route from a butterfly, a calendar spread, and an outright month into a outright middle leg of butterfly, according to a preferred embodiment of the invention.

FIG. 16 is a pair of flow diagrams that illustrate a second implied-out route from a butterfly, a calendar spread, and an outright month into a outright middle leg of butterfly, according to a preferred embodiment of the invention.

FIG. 17 is a pair of flow diagrams that illustrate a second implied-out route from a butterfly, a calendar spread, and an outright month into a outright front leg of butterfly, according to a preferred embodiment of the invention.

FIG. 18 is a pair of flow diagrams that illustrate a second implied-out route from a butterfly, a calendar spread, and an outright month into a outright back leg of butterfly, according to a preferred embodiment of the invention.

FIGS. 19a and 19b are a chart that illustrate a list of potential combinations of futures strategies and contracts for inclusion in trades contemplated in a preferred embodiment of the present invention.

### DETAILED DESCRIPTION OF THE INVENTION

The present invention “aggregates” every implied order held in the order book. This has a number of benefits to the market, including 1) reducing the response times perceived by traders, hence improving their trading performance; 2) elimination of any time element within the pure pro rata trading algorithm (described below), hence improving the fairness of distribution of large trades; and 3) reducing traders' desire to enter multiple orders at depth in the marketplace, to take advantage of any time element to trading. As this reduces the complexity of the order book, it has the benefit of improving performance again.

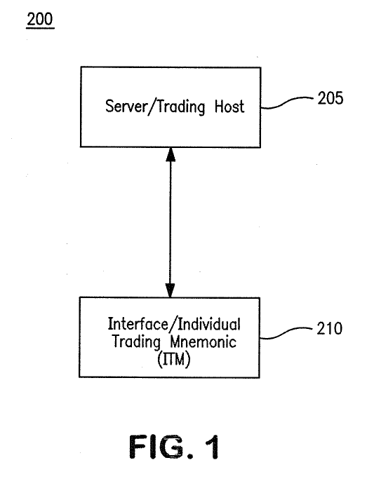

Referring to FIG. 1, a block diagram illustrates an electronic trading system 200 according to a preferred embodiment of the present invention. The system includes one or more servers 205, also referred to as a trading host 205, and one or more interfaces 210, also referred to as an Individual Trading Mnemonic (ITM) 210. The trading host 205 is preferably implemented by the use of one or more general purpose computers, such as, for example, a Sun Microsystems F15k. Each ITM 210 is also preferably implemented by the use of one or more general purpose computers, such as, for example, a typical personal computer manufactured by Dell, Gateway, or Hewlett-Packard. Each of the trading host 205 and the ITM 210 can include a microprocessor. The microprocessor can be any type of processor, such as, for example, any type of general purpose microprocessor or microcontroller, a digital signal processing (DSP) processor, an application-specific integrated circuit (ASIC), a Field Programmable Gate Array (FPGA), or any combination thereof. The trading host may use its microprocessor to read a computer-readable medium containing software that includes instructions for carrying out one or more of the functions of the trading host 205, as further described below.

Each of the trading host 205 and the ITM 210 can also include computer memory, such as, for example, random-access memory (RAM). However, the computer memory of each of the trading host 205 and the ITM 210 can be any type of computer memory or any other type of electronic storage medium that is located either internally or externally to the trading host 205 or the ITM 210, such as, for example, read-only memory (ROM), compact disc read-only memory (CDROM), programmable read-only memory (PROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the trading host 205 or the ITM 210. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 205 and the ITM 210 can also include a database. The database can be any type of computer database for storing, maintaining, and allowing access to electronic information stored therein. The host server 105 preferably resides on a network, such as a local area network (LAN), a wide area network (WAN), or the Internet. The ITM 210 preferably is connected to the network on which the host server resides, thus enabling electronic communications between the trading host 205 and the ITM 210 over a communications connection, whether locally or remotely, such as, for example, an Ethernet connection, an RS-232 connection, or the like.

Strips, packs, bundles, condors, calendar spreads, and butterflies are examples of trading strategies, generally referred to as “futures strategy”, which allow a user to buy or sell several futures contract months, or “legs”, in a single transaction. Specifically, a futures strategy is defined as a predetermined combination of outright month futures contracts. Derivatives products, which are typically made up of a large number of contracts months (e.g., Short Term Interest Rate (STIR) futures), add real value to large users of the market when they offer trading in strategies, as they allow a long term interest rate futures position to be taken, without undertaking the cost and risk of buying or selling each of the individual contract months—known in the market as “legging risk”.

The trading host 205 links the price relationships between the legs and the strategy markets, such that changes in the prices of the legs, will imply in tradable strategies and make them available for trading in an anonymous electronic market. This will ensure that a fair and orderly market is maintained, particularly during times of high volatility, between the strategy and outright markets.

An electronic trading platform, or exchange, such as trading host 205, may allow market participants to submit orders for STIR futures in the form of individual contract months, also referred to as “outrights”. In addition, an exchange may allow market participants to submit an order as a complete strategy—i.e., a combination of two or more contract months, which are also referred to as “legs”. Those strategies are then quoted in the market as an entire strategy.

For futures contracts in which many different delivery months are available to trade, strategy trading is particularly useful to hedgers. This is because taking a completely hedged position may often involve buying or selling multiple contract months to achieve exposure over a number of years. In general, it is far more efficient to perform these kind of “multi-legged” trades by utilizing the strategy markets.

For example, LIFFE CONNECT®, the trading platform used by NYSE Liffe, currently makes the following trading strategies available for trading STIR Futures:

Calendar Spread Buy one contract in the near month; sell one contract in the far month.
Butterfly: Buy one contract in near month, sell two contracts in the far month, buy one contract in a yet farther month. The gaps between the months do not have to be equal or consecutive.
Condor: Buy one near contract month, sell one far month, sell one further month and buy one still further month. The gaps between the months do not have to be equal or consecutive.
Strip: Buy four or more consecutive quarterly delivery months. The number of lots in each leg can vary.
Pack: Buy four quarterly delivery months in the same delivery year.
Bundle: Buy a series of quarterly delivery months representing a series of delivery years of a contract. A bundle is a consecutive series of packs.
Inter-Commodity Spread: Buy a delivery month in one STIR Futures contract and sell the equivalent delivery month in another STIR Futures contract.

Additional definitions include the following:

Implied In prices are defined as prices which are implied INTO a strategy market.
Implied out prices are defined as prices which are implied OUT of one or more strategy markets into an Outright market.
Explicit order is an order entered explicitly by a market participant; either for an outright contract month or for a strategy.

Implied orders are synthetic orders that are generated as a result of the interaction of explicit orders. Implied trading functionality increases liquidity and improves trading opportunities. There are two different forms of implieds—implied-ins and implied-outs. For explicit strategy markets where implied trading functionality applies, the relevant outright contract months, and in specific cases, one or more strategy markets, can generate implied-in prices into strategy markets. Where these implied-in prices represent the best price for a strategy, they may be traded subject to the trade matching algorithm. The interaction of one or more explicit strategy orders and one or more explicit outright orders can generate an implied-out price in another outright market. Where an implied-out price generated by the electronic platform represents the best price for the outright contract month, the order will be traded subject to the trading algorithm.

An example of an implied-in calendar spread is shown in Table 2 below:

TABLE 2

| Month | December | March | December/March Strategy |
|---|---|---|---|
| Bid | 95.000 | | −0.100 |
| | | | Implied |
| Ask | | 95.100 | |

The purchase of a December/March spread is the equivalent of buying a December quarterly delivery and selling a March quarterly delivery. In this example, two explicit orders are entered. This creates an implied-in strategy bid in December/March of −0.100. This price is calculated and held in the electronic trading platform. An incoming strategy order that is entered and matches this price will automatically trade against the explicit outright legs that formed the implied strategy.

As described above, implied-in prices are strategy prices implied into the relevant strategy market based on orders in the outright markets which constitute the strategy's legs, and in specific cases, other outright and strategy orders which can combine to correspond to the same strategy. The use of implied-in prices will have the effect of increasing liquidity in the strategy market, because strategy orders that are directly entered will then trade with strategy orders which have been generated by the host from the more numerous outright orders.

The trading host 205 features a number of trading algorithms, which have been established to provide an active and fair market. An appropriate matching algorithm is assigned to each contract traded on the system. For STIR products, one algorithm that may be applied is referred to hereinafter as the pro-rata algorithm. With all trading algorithms, the highest bid or the lowest offer has priority over other orders at different prices. In the simplest terms, the pro-rata algorithm divides incoming business between all orders at the best market price level. The volume of business allocated to each trader at the best price is proportionate to the amount of volume they have in the market at that price. The system calculates this in the following order:
A match list is created—i.e., a list of all counterparties to the trade;
The tradable volume is calculated;
The tradable volume is allocated to all counterparties.

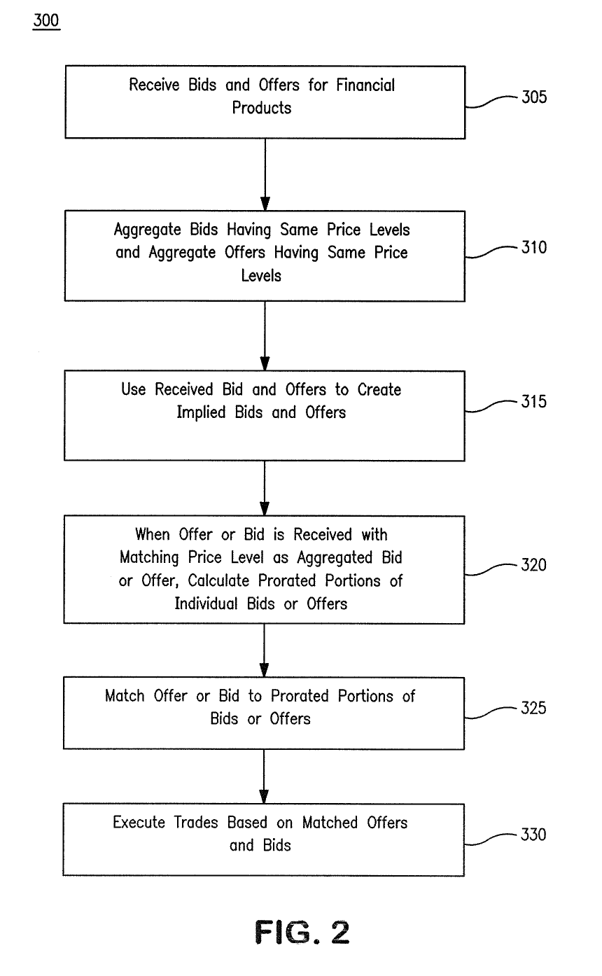

Referring to FIG. 2, a flow chart 300 illustrates a method of facilitating trading of STIR futures and other financial products according to a preferred embodiment of the invention. In the first step 305, the trading host 205 receives bids and offers for a variety of financial products. Each bid or offer includes a price, a number of lots, and a time at which the bid or offer is received. At step 310, for any given financial product, the trading host 205 aggregates received bids having the same price level, and also aggregates received offers having the same price level. At step 315, the trading host 205 uses received bids and offers to imply in or imply out bids or offers, as previously described. Notably, the aggregation of bids and offers at step 315 occurs regardless of when the bids or offers are received. Then, at step 320, when an offer or bid is received that would match an aggregated bid or offer, the trading host 205 calculates prorated portions of each of the individual bids or offers that constitute the aggregated bid or offer, based on the number of lots in the received offer or bid. At step 325, the trading host 205 matches the received offer or bid with the respective prorated portions of the individual bids or offers. Finally, at step 30, the trading host 330 executes trades based on the matching offers and bids.

The trading host 205 aggregates every implied order held in the order book. This has a number of benefits to the market, including the following:
Aggregation of implied orders significantly improves system performance, because the trading host 205 no longer maintains each separate implied order in time order. Instead, the trading host 205 aggregates all orders at the same price level, and performs the pro-rata calculations at the point of trade, rather than at the point of order entry.
Aggregation of implied orders eliminates the use of “time” by market participants to influence the allocations provided by the pro-rata trading algorithm, thus improving the fairness of distribution of large trades. This is because once the aggregation of implied prices has taken place, the trading host 205 no longer applies any time element to the orders to which it distributes volume.
In turn, the elimination of the time element has the effect of further reducing the likelihood that traders will enter multiple orders at depth in the marketplace. Typically, traders have used this strategy to take advantage of any time element to trading. For example, the entry of GTC orders before market close has been a popular trading strategy, as an attempt to gain a perceived time advantage at the start of trading the following day. As traders move away from this trading strategy, the complexity of the order book will likely be reduced, thus yielding a further performance improvement.
Aggregation of implied orders also enables the system to introduce more functionality at the trading host 205 level which will improve the quality of the market. For example, the trading host 205 can make various different types of financial products available for trading, such as implied-in strips, packs, bundles and condors, as defined above.

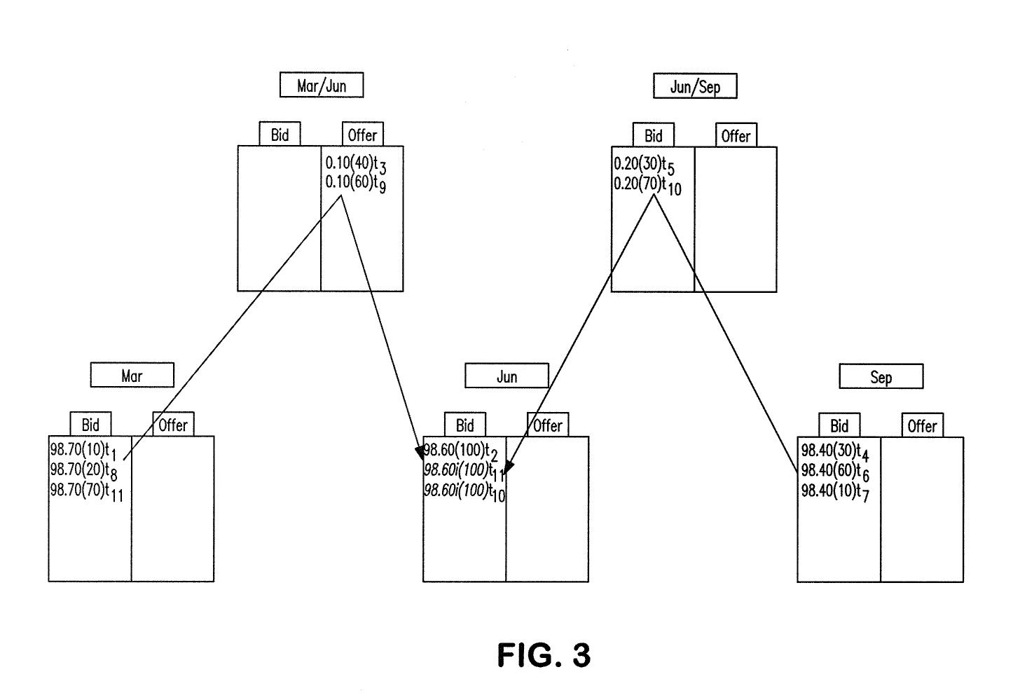

Referring to FIG. 3, an example of aggregation of implied orders is shown. Referring also to Table 5 below, an incoming offer in the June Euribor future of 150 lots at 98.60 will result in the following trading volume allocation:

TABLE 5

| Order | Original Volume | Traded Volume |
|---|---|---|
| t1 | 10 | 5 |
| t2 | 100 | 50 |
| t3 | 40 | 20 |
| t4 | 30 | 15 |
| t5 | 30 | 15 |
| t6 | 60 | 30 |
| t7 | 10 | 5 |
| t8 | 20 | 10 |
| t9 | 60 | 30 |
| t10 | 70 | 35 |
| t11 | 70 | 35 |

The above example assumes that a pro-rata trading algorithm is used.

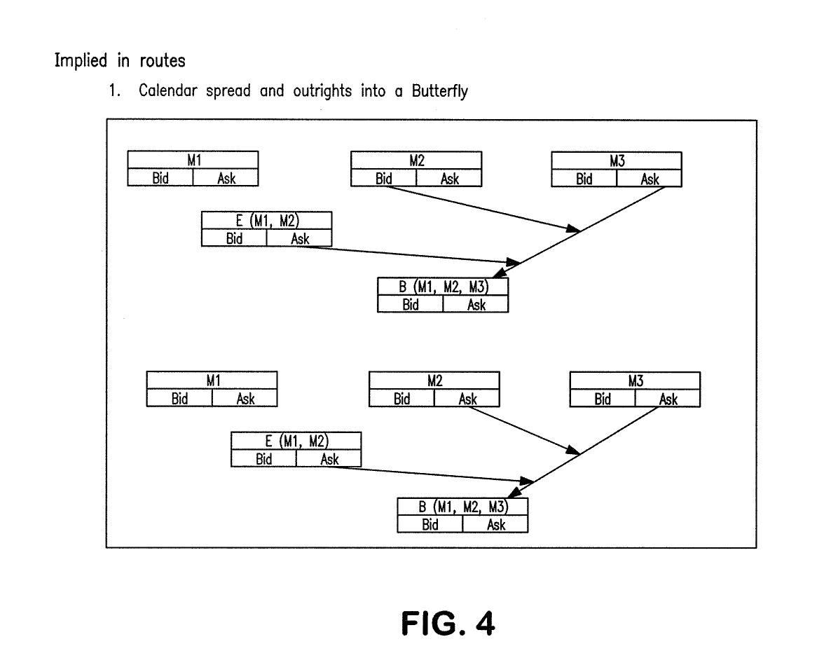

Referring to FIG. 4, two flow diagrams illustrate a first implied-in route from a calendar spread and outright months into a butterfly, according to a preferred embodiment of the invention. In the top flow diagram, the calendar spread is an offer that covers month 1 and month 2, the first outright month is a bid that covers month 2, the second outright month is an offer that covers month 3, and the butterfly is an implied offer that covers months 1, 2, and 3. The bottom flow diagram show the exact reverse of the top: the calendar spread is a bid that covers month 1 and month 2, the first outright month is an offer that covers month 2, the second outright month is a bid that covers month 3, and the butterfly is an implied bid that covers months 1, 2, and 3.

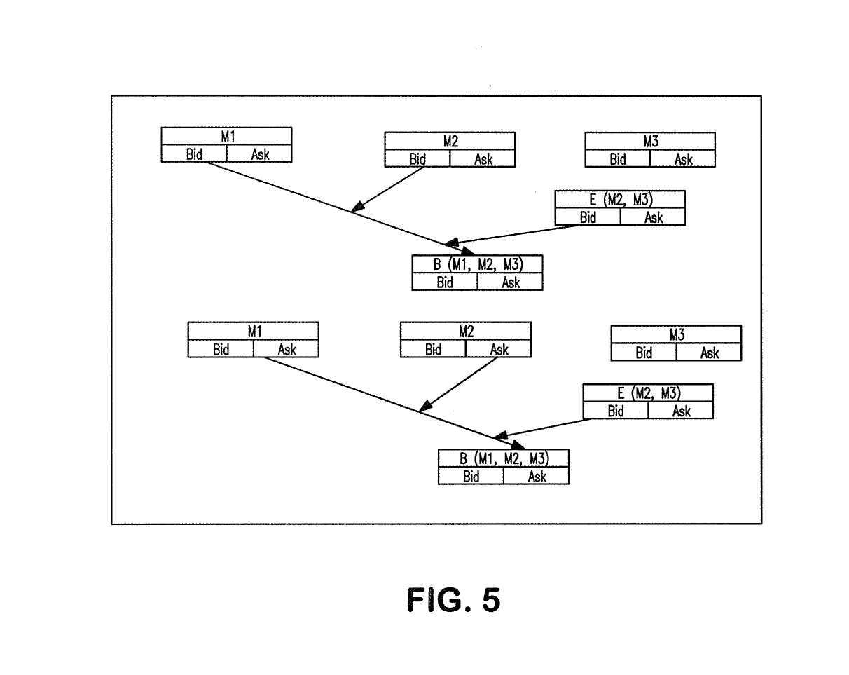

Referring to FIG. 5, two flow diagrams illustrate a second implied-in route from a calendar spread and outright months into a butterfly, according to a preferred embodiment of the invention. In the top flow diagram, the calendar spread is an offer that covers month 2 and month 3, the first outright month is a bid that covers month 1, the second outright month is an offer that covers month 2, and the butterfly is an implied bid that covers months 1, 2, and 3. The bottom flow diagram shows the exact reverse of the top: the calendar spread is a bid that covers month 2 and month 3, the first outright month is an offer that covers month 1, the second outright month is an offer that covers month 2, and the butterfly is an implied offer that covers months 1, 2, and 3.

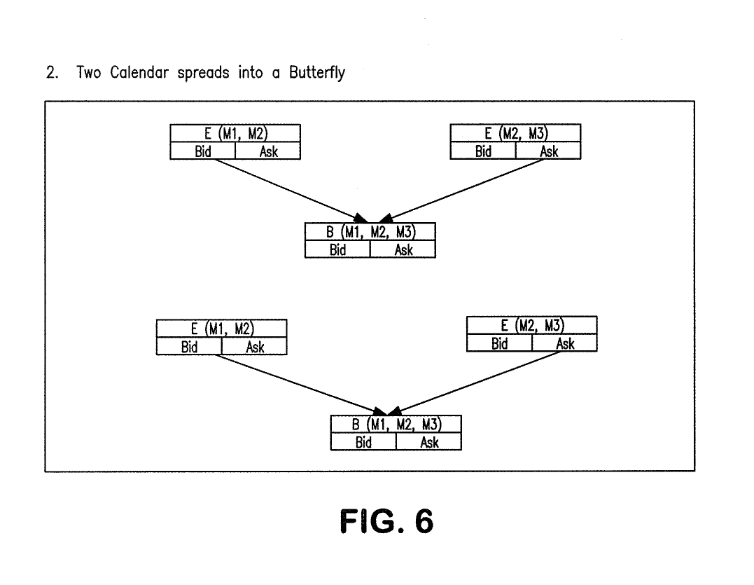

Referring to FIG. 6, two flow diagrams illustrate an implied-in route from two calendar spreads into a butterfly, according to a preferred embodiment of the invention. In the top flow diagram, the first calendar spread is a bid that covers month 1 and month 2, the second calendar spread is an offer that covers month 1 and month 3, and the butterfly is an implied bid that covers months 1, 2, and 3. The bottom flow diagram shows the exact reverse of the top: the first calendar spread is an offer that covers month 1 and month 2, the second calendar spread is a bid that covers month 2 and month 3, and the butterfly is an implied offer that covers months 1, 2, and 3.

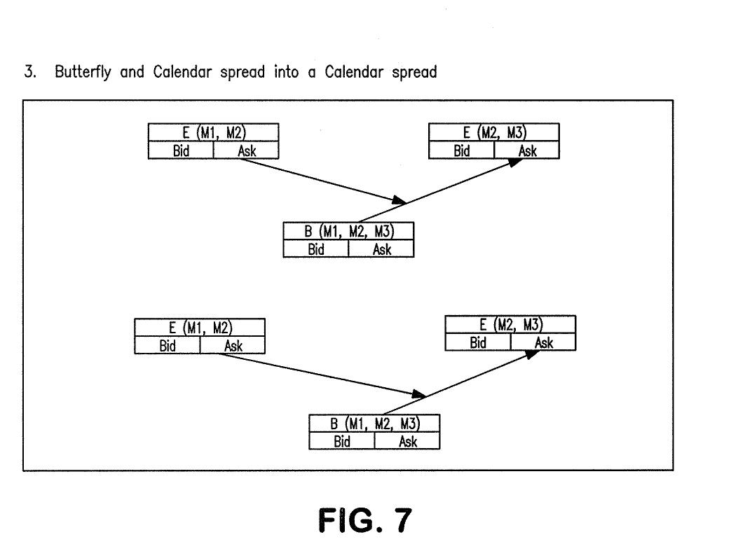

Referring to FIG. 7, two flow diagrams illustrate a first implied-in route from a butterfly and a calendar spread into a calendar spread, according to a preferred embodiment of the invention. In the top flow diagram, the butterfly is a bid that covers months 1, 2, and 3, the first calendar spread is an offer that covers month 1 and month 2, and the second calendar spread is an implied offer that covers months 2 and 3. The bottom flow diagram shows the exact reverse of the top: the butterfly is an offer that covers months 1, 2, and 3, and the first calendar spread is a bid that covers month 1 and month 2, and the second calendar spread is an implied offer that covers months 2 and 3.

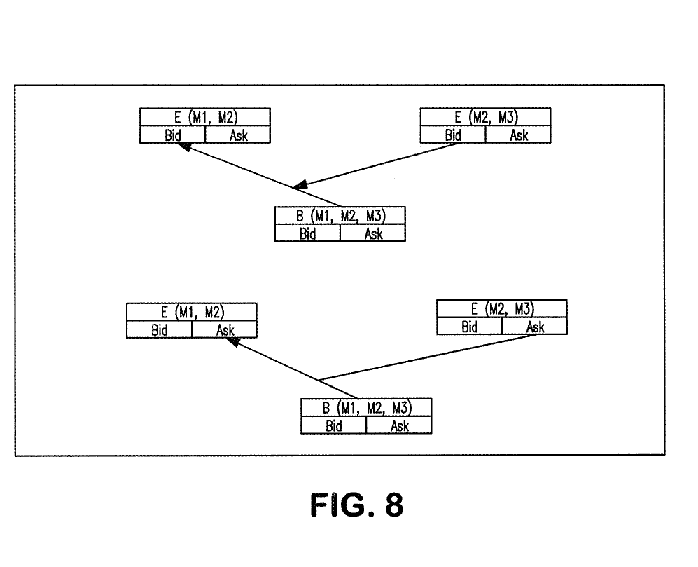

Referring to FIG. 8, two flow diagrams illustrate a second implied-in route from a butterfly and a calendar spread into a calendar spread, according to a preferred embodiment of the invention. In the top flow diagram, the butterfly is a bid that covers months 1, 2, and 3, the first calendar spread is a bid that covers months 2 and 3, and the second calendar spread is an implied bid that covers month 1 and month 3. The bottom flow diagram shows the exact reverse of the top: the butterfly is an offer that covers months 1, 2, and 3, the first calendar spread is an offer that covers months 2 and 3, and the second calendar spread is an implied offer that covers month 1 and month 2.

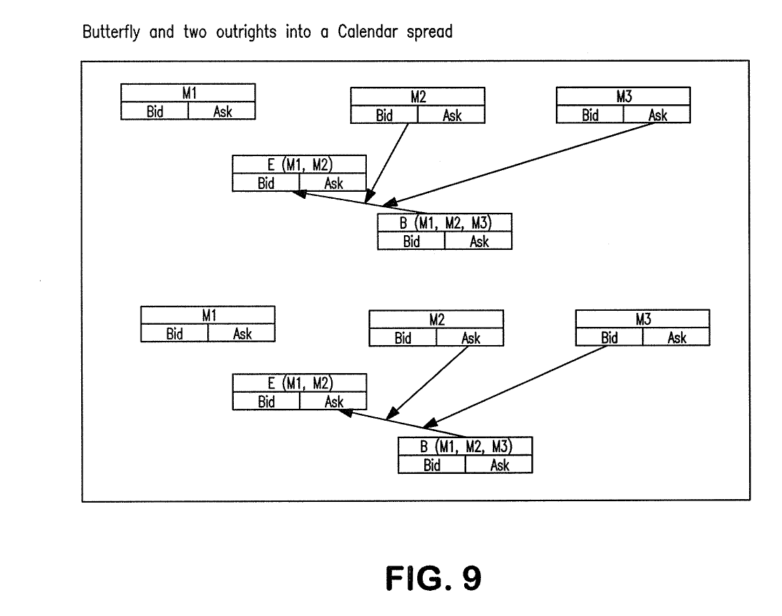

Referring to FIG. 9, two flow diagrams illustrate an implied-in route from a butterfly and two outright months into a calendar spread, according to a preferred embodiment of the invention. In the top flow diagram, the butterfly is a bid that covers months 1, 2, and 3, the first outright month is a bid that covers month 2, the second outright month is an offer that covers month 3, and the calendar spread is an implied bid that covers months 1 and 2. The bottom flow diagram shows the exact reverse of the top: the butterfly is an offer that covers months 1, 2, and 3, the first outright month is an offer that covers month 2, the second outright month is a bid that covers month 3, and the calendar spread is an implied offer that covers months 1 and 2.

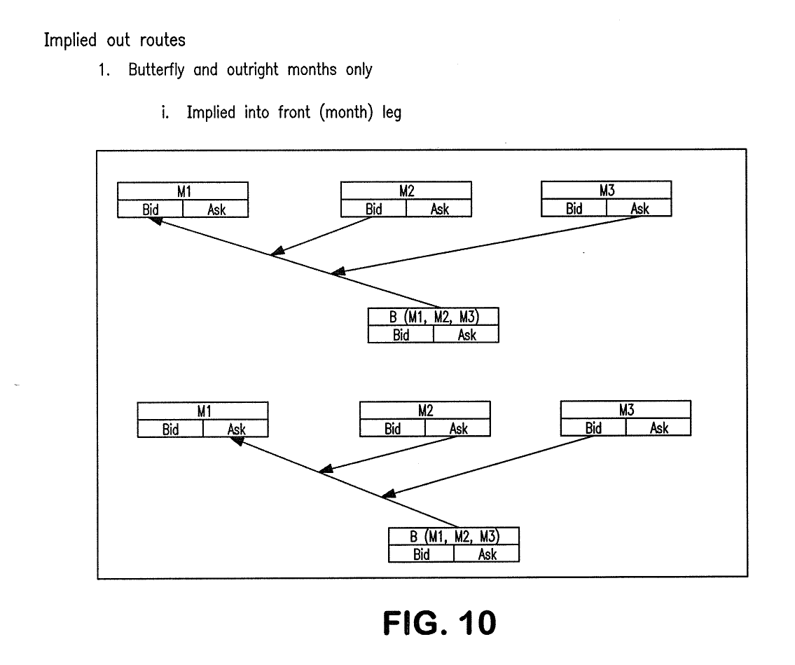

Referring to FIG. 10, two flow diagrams illustrate an implied-out route from a butterfly and outright months into a outright front leg of a butterfly, according to a preferred embodiment of the invention. In the top flow diagram, the butterfly is a bid that covers months 1, 2, and 3, the first outright month is a bid that covers month 2, the second outright month is an offer that covers month 3, and the third outright month is an implied bid that covers month 1. The bottom flow diagram shows the exact reverse of the top: the butterfly is an offer that covers months 1, 2, and 3, the first outright month is an offer that covers month 2, the second outright month is a bid that covers month 3, and the third outright month is an implied offer that covers month 1.

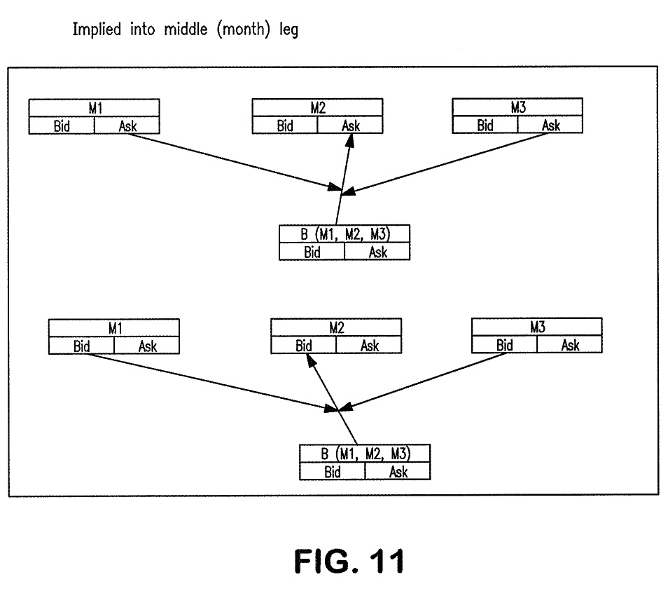

Referring to FIG. 11, two flow diagrams illustrate an implied-out route from a butterfly and outright months into a outright middle leg of a butterfly, according to a preferred embodiment of the invention. In the top flow diagram, the butterfly is a bid that covers months 1, 2, and 3, the first outright month is an offer that covers month 1, the second outright month is an offer that covers month 3, and the third outright month is an implied offer that covers month 2. The bottom flow diagram shows the exact reverse of the top: the butterfly is an offer that covers months 1, 2, and 3, the first outright month is a bid that covers month 1, the second outright month is a bid that covers month 3, and the third outright month is an implied bid that covers month 2.

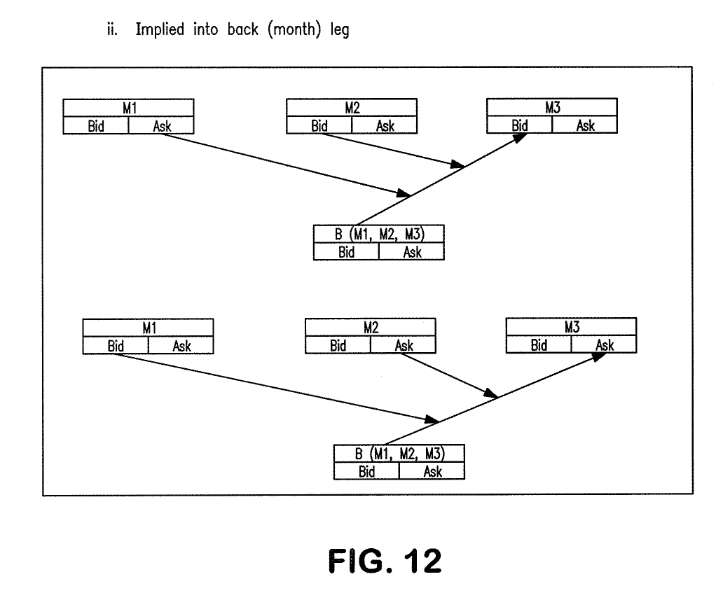

Referring to FIG. 12, two flow diagrams illustrate an implied-out route from a butterfly and outright months into a outright back leg of a butterfly, according to a preferred embodiment of the invention. In the top flow diagram, the butterfly is a bid that covers months 1, 2, and 3, the first outright month is an offer that covers month 1, the second outright month is a bid that covers month 2, and the third outright month is an implied bid that covers month 3. The bottom flow diagram shows the exact reverse of the top: the butterfly is an offer that covers months 1, 2, and 3, the first outright month is a bid that covers month 1, the second outright month is an offer that covers month 2, and the third outright month is an implied offer that covers month 3.

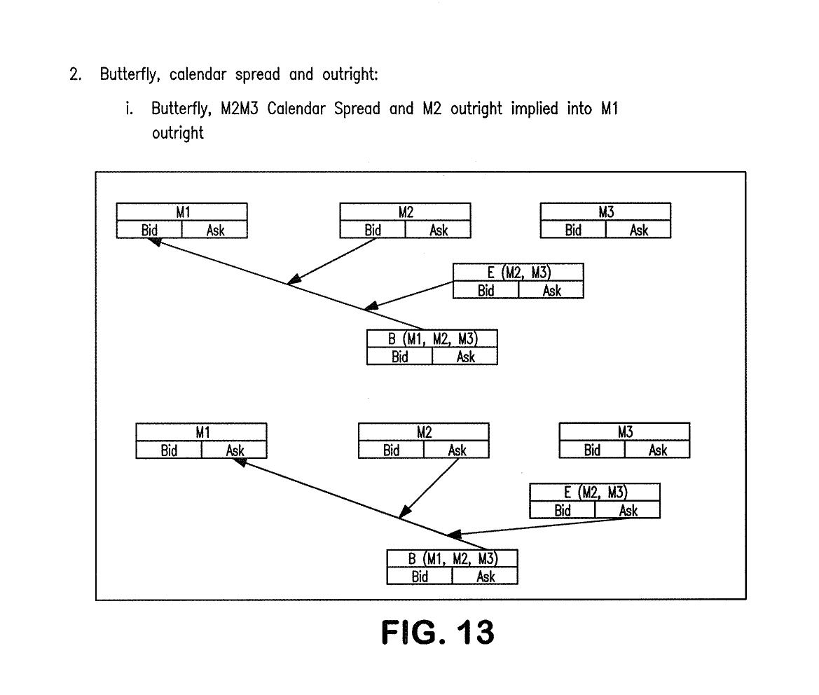

Referring to FIG. 13, two flow diagrams illustrate an implied-out route from a butterfly, a calendar spread, and an outright month into a outright front leg of butterfly, according to a preferred embodiment of the invention. In the top flow diagram, the butterfly is a bid that covers months 1, 2, and 3, the calendar spread is a bid that covers months 2 and 3, the first outright month is a bid that covers month 2, and the second outright month is an implied bid that covers month 1. The bottom flow diagram shows the exact reverse of the top: the butterfly is an offer that covers months 1, 2, and 3, the calendar spread is an offer that covers month 2 and month 3, the first outright month is an offer that covers month 2, and the second outright month is an implied offer that covers month 1.

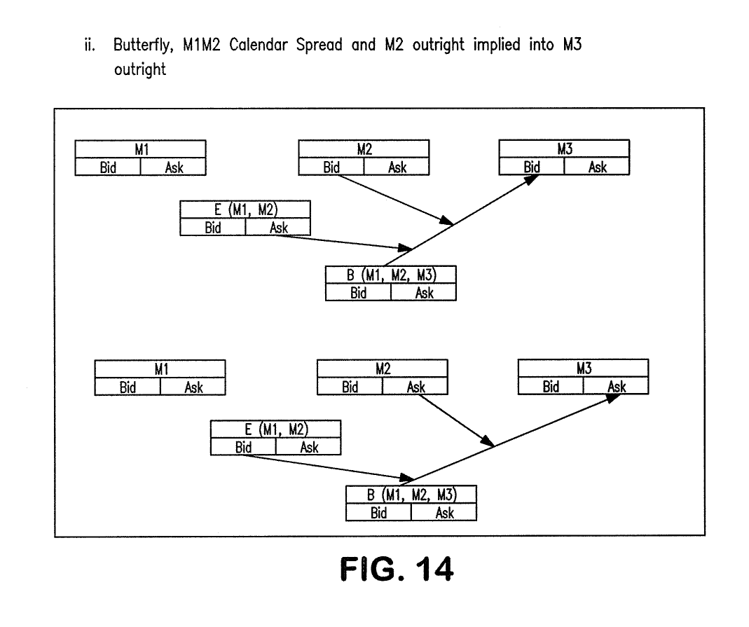

Referring to FIG. 14, two flow diagrams illustrate an implied-out route from a butterfly, a calendar spread, and an outright month into a outright back leg of butterfly, according to a preferred embodiment of the invention. In the top flow diagram, the butterfly is a bid that covers months 1, 2, and 3, the calendar spread is an offer that covers months 1 and 2, the first outright month is a bid that covers month 2, and the second outright month is an implied bid that covers month 3. The bottom flow diagram shows the exact reverse of the top: the butterfly is an offer that covers months 1, 2, and 3, the calendar spread is a bid that covers month 1 and month 2, the first outright month is an offer that covers month 2, and the second outright month is an implied offer that covers month 3.

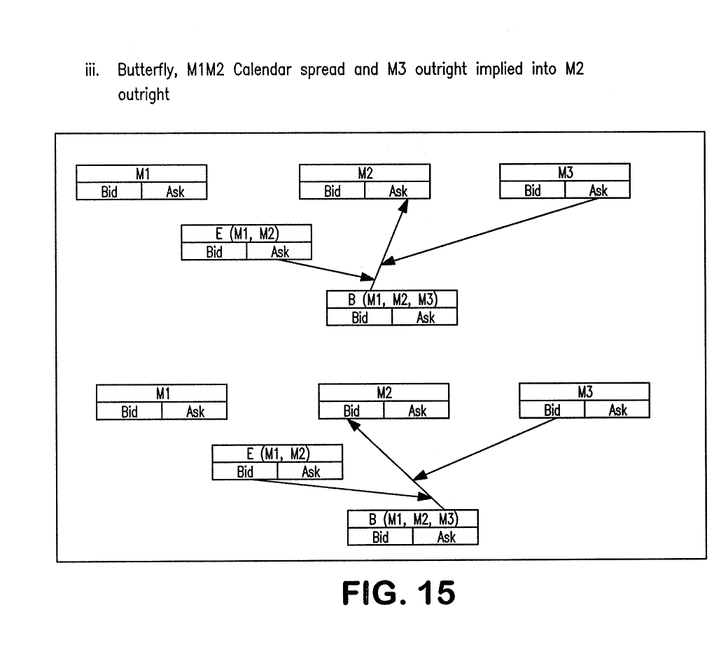

Referring to FIG. 15, two flow diagrams illustrate an implied-out route from a butterfly, a calendar spread, and an outright month into a outright middle leg of butterfly, according to a preferred embodiment of the invention. In the top flow diagram, the butterfly is a bid that covers months 1, 2, and 3, the calendar spread is an offer that covers months 1 and 2, the first outright month is an offer that covers month 3, and the second outright month is an implied offer that covers month 2. The bottom flow diagram shows the exact reverse of the top: the butterfly is an offer that covers months 1, 2, and 3, the calendar spread is a bid that covers month 1 and month 2, the first outright month is a bid that covers month 3, and the second outright month is an implied bid that covers month 2.

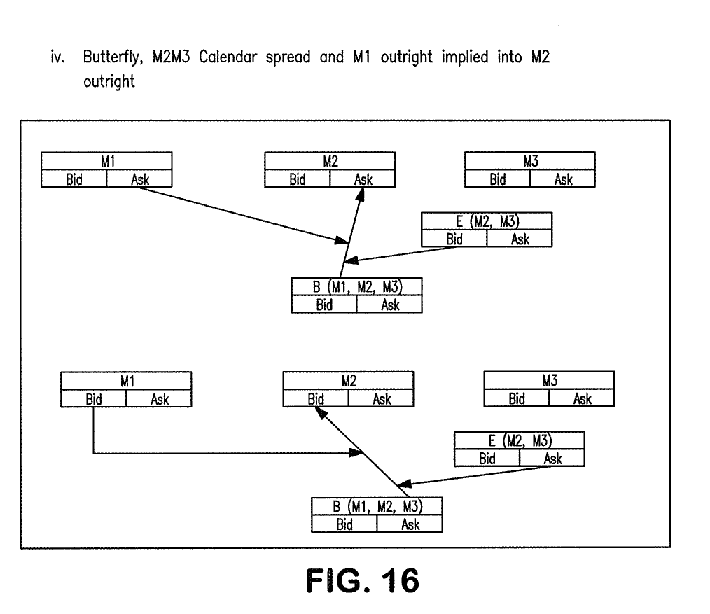

Referring to FIG. 16, two flow diagrams illustrate an implied-out route from a butterfly, a calendar spread, and an outright month into a outright middle leg of butterfly, according to a preferred embodiment of the invention. In the top flow diagram, the butterfly is a bid that covers months 1, 2, and 3, the calendar spread is a bid that covers months 2 and 3, the first outright month is an offer that covers month 1, and the second outright month is an implied offer that covers month 2. The bottom flow diagram shows the exact reverse of the top: the butterfly is an offer that covers months 1, 2, and 3, the calendar spread is an offer that covers month 2 and month 3, the first outright month is a bid that covers month 1, and the second outright month is an implied bid that covers month 2.

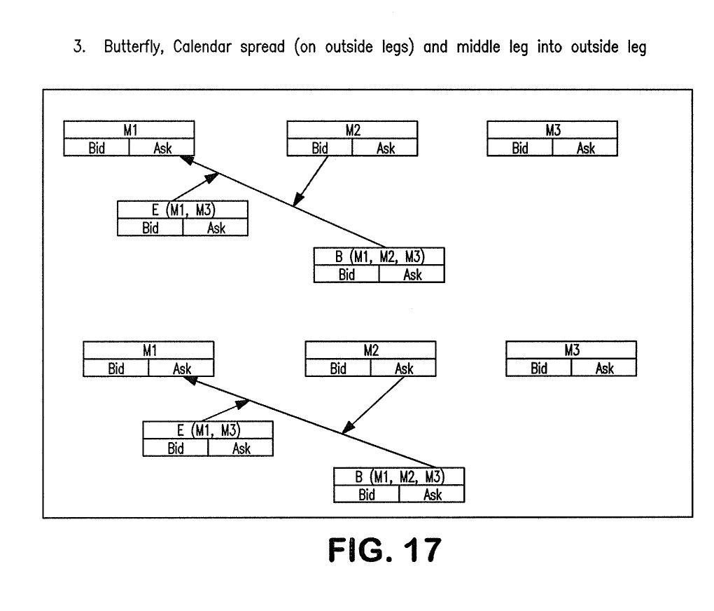

Referring to FIG. 17, two flow diagrams illustrate an implied-out route from a butterfly, a calendar spread, and an outright month into a outright front leg of butterfly, according to a preferred embodiment of the invention. In the top flow diagram, the butterfly is a bid that covers months 1, 2, and 3, the calendar spread is a bid that covers months 1 and 3, the first outright month is a bid that covers month 2, and the second outright month is an implied bid that covers month 1. The bottom flow diagram shows the exact reverse of the top: the butterfly is an offer that covers months 1, 2, and 3, the calendar spread is an offer that covers month 1 and month 3, the first outright month is an offer that covers month 2, and the second outright month is an implied offer that covers month 1.

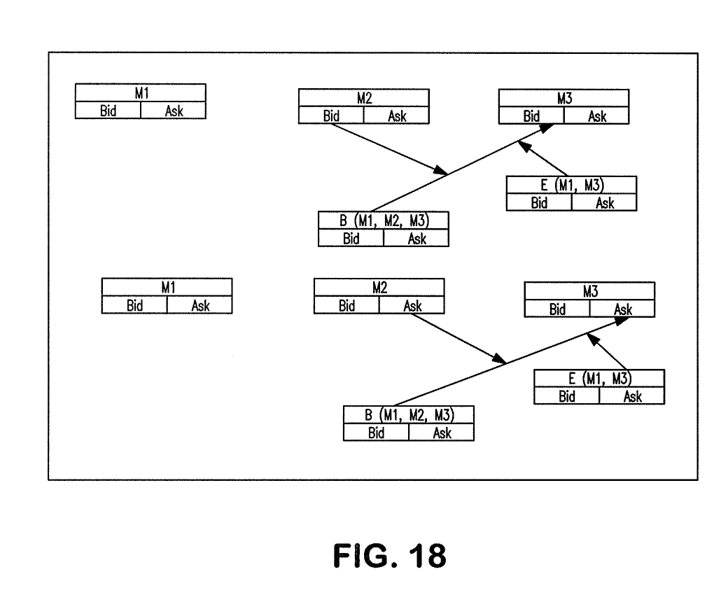

Referring to FIG. 18, two flow diagrams illustrate an implied-out route from a butterfly, a calendar spread, and an outright month into a outright back leg of butterfly, according to a preferred embodiment of the invention. In the top flow diagram, the butterfly is a bid that covers months 1, 2, and 3, the calendar spread is an offer that covers months 1 and 3, the first outright month is a bid that covers month 2, and the second outright month is an implied bid that covers month 3. The bottom flow diagram shows the exact reverse of the top: the butterfly is an offer that covers months 1, 2, and 3, the calendar spread is a bid that covers month 1 and month 3, the first outright month is an offer that covers month 2, and the second outright month is an implied offer that covers month 3.

Within the previous invention of Aggregate Implieds, the determination of how to combine orders to create implied prices was based upon the strategy definitions. Each strategy has a definition, which is essentially a description of a one-lot bid in the strategy in terms of its constituent legs. For example, buying one lot of a futures calendar spread strategy involves buying one lot in one futures expiry (the front leg of the strategy) and selling one lot in a later dated futures expiry (the back leg of the strategy.) As a further example, buying one lot of a futures butterfly strategy involves buying one lot in one futures expiry (the front leg of the strategy), selling two lots in a later dated futures expiry (the middle leg of the strategy), and selling one lot in a futures expiry which has a later date to expiry than the second leg (the back leg of the strategy). The leg ratio is a number whose absolute magnitude is the number of lots in the description, and whose sign is positive for a buy leg, negative for a sell leg.

Using this notion, the strategy description can be written as, for example:

S=L1−L2 (futures calendar spread)

S=L1−2*L2+L3 (futures butterfly),

where S indicates the strategy and Ln indicates the nth leg. The above equations illustrate how the price of a strategy can be determined from the price of its legs. In this manner, implied-in prices are automatically calculated. The descriptions can be rearranged like mathematical equations to yield a description for any leg of a strategy in terms of the other components of that strategy. For example, the description of leg 2 of a futures calendar spread is:

L2=+L1−S

An implied price for any component can be found by substituting explicit prices for the elements on the right hand side of the description. When generating the price of an implied bid, if the ratio for the element is positive, then the element is substituted with an explicit bid price. When generating the price of an implied bid, if the ratio for the element is negative, then the element is substituted with an explicit offer price. For example, taking the previous equation for determining the price of L2 of a futures calendar spread strategy using a strategy price and the price of the other leg, the price of an implied bid is determined as:

L2 (Implied) Bid Price=+L1 Bid Price−S Ask Price

When generating the price of an implied ask, if the ratio for the element is positive, then the element is substituted with an explicit ask price. When generating the price of an implied ask, if the ratio for the element is negative then the element is substituted with an explicit bid price. Again, taking the previous equation for determining the price of L2 of a futures calendar spread strategy using a strategy price and the price of the other leg, the price of an implied ask is determined as:

L2 (Implied) Ask Price=+L1 Ask Price−S Bid Price

The approach described above is flexible, in that it allows the generation of implied prices using any single strategy to be fully automated. However, this approach does not allow for multiple strategy markets to be combined to generate implied prices. For example, an order in a futures calendar spread having legs L1 and L2 can be combined with another order in a futures calendar spread having legs L2 and L3 to generate prices in a futures butterfly having legs L1, L2 and L3. To make this possible, the Aggregate Implied implementation has been extended to incorporate the concept of Implied Trading Patterns. This idea is best illustrated using the notation described below for illustrating how orders can be combined to generate implied prices.

One way of viewing each order is to represent it as a set of ratios in the available markets. For example, if considering outright markets L1, L2, and L3, then:
An L1 ask would be represented as a −1 in L1 and as a 0 in L2 and L3
An L2/L3 calendar spread bid would be represented as a 0 in L1, a +1 in L2 and a −1 in L3
An L1/L2/L3 butterfly bid would be represented as a +1 in L1, a −2 in L2 and a +1 in L3
   This can be illustrated in tabular form as follows:

| | L1 | L2 | L3 |
|---|---|---|---|
| L1 Ask | −1 | 0 | 0 |
| L2/L3 Calendar Spread Bid | 0 | +1 | −1 |
| L1/L2/L3 Butterfly Bid | +1 | −2 | +1 |

The result of combining any set of orders is given by simply adding up all of the columns for each outright market. If a set of orders, when combined, result in an empty market (i.e., each outright market sum is zero), then that combination of orders can trade with one another. Such a set of orders is referred to as an Implied Trading Pattern. For example, a simple implied-in trading with an L1/L2 calendar spread explicit order may be represented in tabular form as follows:

| | L1 | L2 | L3 |
|---|---|---|---|
| L1 Bid | +1 | 0 | 0 |
| L2 Ask | 0 | −1 | 0 |
| L1/L2 Calendar Spread Ask | −1 | +1 | 0 |
| Total Ratio | 0 | 0 | 0 |

A subset of all but one of the orders from an Implied Trading Pattern may be used to generate an implied price in the market of the order that has been removed from the set. For example, taking the first two orders from the previous set, the following table illustrates as follows:

| | L1 | L2 | L3 |
|---|---|---|---|
| L1 Bid | +1 | 0 | 0 |
| L2 Ask | 0 | −1 | 0 |
| Total Ratio | +1 | −1 | 0 |

The result in the case shown above from combining two orders is equivalent to an L1/L2 calendar spread bid. The resulting implied order from such combinations is always on the opposite side of market to the removed order, because the resulting implied order would have traded with the order that has been removed from the Implied Trading Pattern.

The Implied Trading Patterns not only provide the set of orders that match, but also provide the price of each implied order and the required ratios. In the same way as prices are generated for the existing invention of Aggregate Implieds, the price of an implied order generated from an Implied Trading Pattern is the sum of the prices multiplied by the ratios of the other components. It is noted that an Ask order has a ratio of −1 and Bid order has a ratio of +1. For example, for the Implied Trading Pattern illustrated tabularly below:

| | | Order | | | |
|---|---|---|---|---|---|
| | Price | Ratio | L1 | L2 | L3 |
| L3 Ask | 95.055 | −1 | 0 | 0 | −1 |
| L1/L2 Calendar Spread Ask | 0.005 | −1 | −1 | +1 | 0 |
| L1/L2/L3 Butterfly Bid | −0.005 | +1 | +1 | −2 | +1 |
| L2 Bid | 95.060 | +1 | 0 | +1 | 0 |
| Total Ratio | | | 0 | 0 | 0 |

The price of an implied Bid in market L3 would be:

$$\begin{matrix}L 3 Bid Price = ( L 1 \text{/} L 2 \text{/} L 3 Butterfly Bid Price \times ( + 1 ) ) + \\ ( L 2 Bid Price \times ( + 1 ) ) + \\ ( L 1 \text{/} L 2 Calendar Spread Ask Price \times ( - 1 ) ) \\ = L 1 \text{/} L 2 \text{/} L 3 Butterfly Bid Price + L 2 Bid Price - \\ L 1 \text{/} L 2 Calendar Spread\end{matrix}$$

$$\begin{matrix}Ask Price = - 0.005 + 95.060 - 0.005 \\ = 95.050\end{matrix}$$

The new implementation of implied price generation within the trading system has been based upon extending the existing Aggregate Implied invention with the use of the Implied Trading Pattern approach. Implied Trading Patterns are specified in the trading systems configuration data. In a preferred embodiment of the invention, a specification of a supported list of Implied Trading Patterns may be provided by a trading system operator. This approach provides flexibility, as any method of combining orders for implied orders can be implemented by simply adding the required combinations to the configuration data.

The configuration data for Implied Trading Patterns is stored in the database as a generalized form or abstract pattern in a similar way to that illustrated above. When combined with the available markets for a given contract, these abstract patterns can be used to generate the actual concrete tradable scenarios within the trading system. For example, to provide implied-in orders and implied-out orders for futures calendar spreads, the following abstract pattern will be defined as shown below:

| | L1 | L2 |
|---|---|---|
| L1 Bid | +1 | 0 |
| L2 Ask | 0 | −1 |
| L1/L2 Calendar Spread Ask | −1 | +1 |

When an actual futures calendar spread strategy is created, the corresponding concrete Implied Trading Pattern is created from this abstract pattern. For example, if a calendar spread having legs in the March 2012 and June 2012 expires is created, then the following concrete Implied Trading Pattern will be created as shown below:

| | March | June |
|---|---|---|
| | 2012 | 2012 |
| March 2012 Bid | +1 | 0 |
| June 2012 Ask | 0 | −1 |
| March 2012/June 2012 | −1 | +1 |
| Calendar Spread Ask | | |

This approach ensures that each Implied Trading Pattern need only be specified once, rather than having to be specified for every possible combination of markets that are available to trade.

In order to ease the representation of the many implied combinations available, the implied combinations can be displayed as a set of ratios from the associated markets. An outright may be represented by a ratio of 1 with negative and positive notations representing the side of market. Strategy markets will use the same representation for the side of market taking into account the ratio applied to each leg. For example:

| | March | June | September |
|---|---|---|---|
| March Ask | −1 | 0 | 0 |
| June September (E) Bid | 0 | +1 | −1 |
| March June September (B) Bid | +1 | −2 | +1 |

Implied trading combinations are identified when the sum of the ratios of a combination equals zero. For example:

| | March | June | September |
|---|---|---|---|
| March Ask | −1 | 0 | 0 |
| June Bid | 0 | +1 | 0 |
| June September (E) Bid | 0 | +1 | −1 |
| March June September (B) Bid | +1 | −2 | +1 |
| Total | 0 | 0 | 0 |

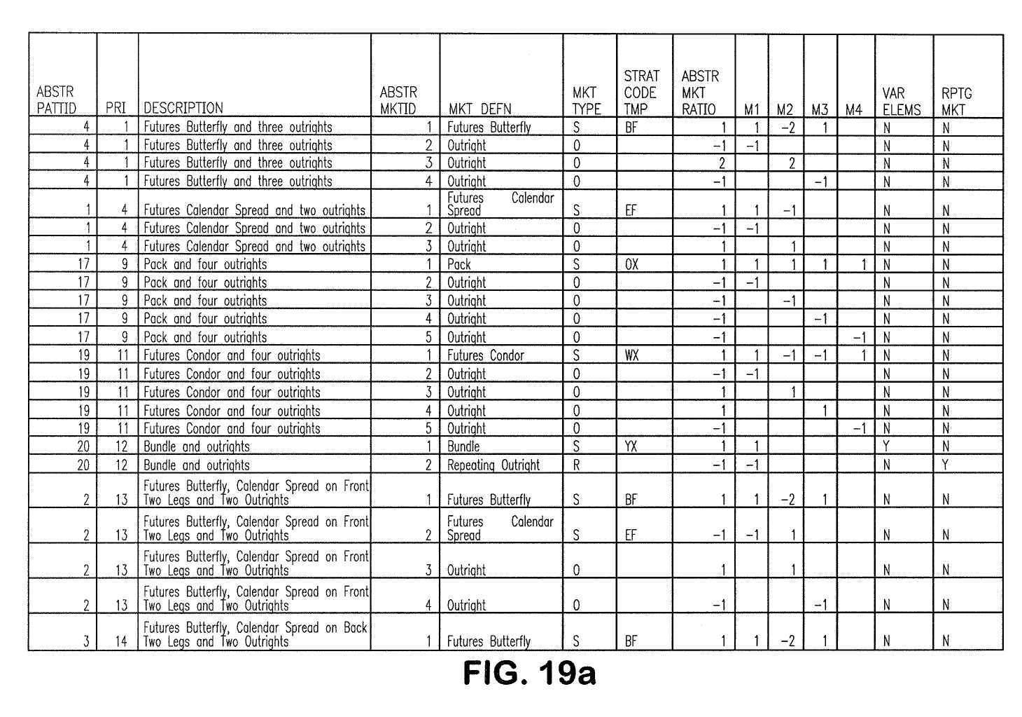

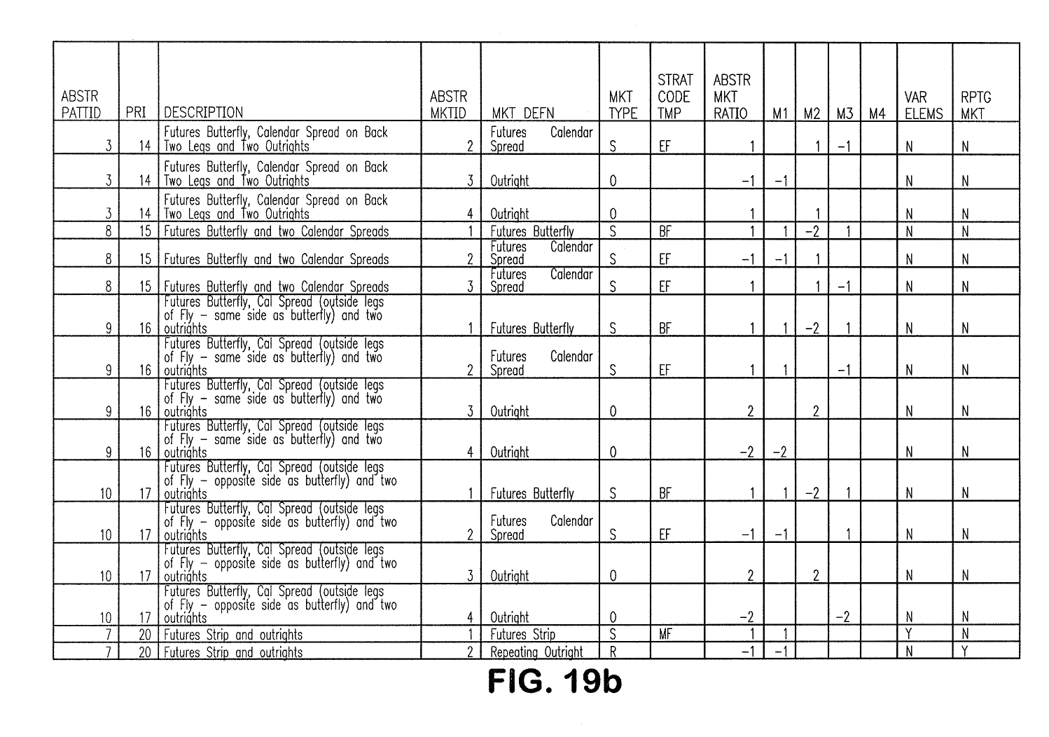

In a preferred embodiment of the present invention, FIGS. 19a and 19b illustrate a list of implied patterns that are available for trading.

In a preferred embodiment of the invention, implied patterns are configured on a per product basis. In a preferred embodiment of the present invention, implied prices at best price are accumulated for a product for each pattern configured for that product. In a preferred embodiment of the present invention, the publication of implied prices can also be configured on a per strategy type and/or per product basis. In a preferred embodiment of the invention, a trading system operator may provide a list of supported implied patterns on a per product basis and also provide configuration per strategy type and/or per product indicating whether implied prices are to be published.

In a preferred embodiment of the invention, there are two market types: outright markets and recognized strategy code markets. In a preferred embodiment of the invention, if an implied is generated in a market with a clip ratio greater than 1, such an implied price and volume is not published.

Multiple counting is a phenomenon in which a parent order can generate multiple implied prices onto the same side of the implied market via multiple implied trading patterns. The effect of multiple counting is that the total implied volume in that market is greater than actual volume which is available for trading. A parent order can currently generate many implied orders such that the parent order is effectively multiple counted. Preferably, if a parent order can generate an implied order into the same side of another market via multiple implied trading patterns, then only the tradable volume is published. In a preferred embodiment, the tradable volume which originates from the route with the highest pattern priority is published.

Double trading may occur when a parent order can generate multiple implied prices into both sides of an implied market via multiple implied trading patterns. In a preferred embodiment of the invention, if a parent order can generate an implied price into both sides of another market but are not crossed, the total implied volume for each implied trading pattern should be published. Preferably, if a parent order can generate an implied order into both sides of another market via multiple implied trading patterns, the implied orders are permitted to trade against each other, where possible. Where there is matching implied volume of one lot originating from a single parent order of one lot (or two lots for the middle leg of a butterfly), this cannot be traded as it would require the parent to trade against itself and therefore must trade in two lot intervals. The remaining one lot should remain in the order book but should not be published to the market.

In a preferred embodiment of the invention, where an implied price trades with an explicit order, any potential price improvement is allocated to the incoming order. In a preferred embodiment of the invention, where an incoming explicit order crosses an implied price in a outright market which originates from more than one strategy, and it is impossible to allocate the price improvement to the incoming order, then the price improvement is allocated to the first strategy defined within the Implied Trading Pattern used to generate the implied order.

The following scenario provides an example of the double counting phenomenon. The table below illustrates exemplary prices in certain markets:

| | March | June | September |
|---|---|---|---|
| March Bid | +1 | 0 | 0 |
| June Ask (2) | 0 | −2 | 0 |
| September Bid | 0 | 0 | +1 |
| March June (E) Bid | +1 | −1 | 0 |

Prices can be implied in the Mar Jun Sep Butterfly bid through two implied trading patterns, using the Jun Ask and Sep bid for both implied trading patterns. Firstly the outright markets can imply directly into the Mar Jun Sep Butterfly Bid as follows:

| | March | June | September |
|---|---|---|---|
| March Bid | +1 | 0 | 0 |
| June Ask (2) | 0 | −2 | 0 |
| September Bid | 0 | 0 | +1 |
| March June September (B) Implied Bid | +1 | −2 | +1 |

Secondly the Mar Jun (E) Bid, Jun Ask (1) and Sep Bid can also imply into Mar Jun Sep Butterfly Bid as follows:

| | March | June | September |
|---|---|---|---|
| March June (E) Bid | +1 | −1 | 0 |
| June Ask (1) | 0 | −1 | 0 |
| September Bid | 0 | 0 | +1 |
| March June September (B) Implied Bid | +1 | −2 | +1 |

The following scenario provides an example of the double trading phenomenon. The table below illustrates exemplary prices in certain markets:

| | March | June | September |
|---|---|---|---|
| March Ask | −1 | 0 | 0 |
| June Bid (2) | 0 | −2 | 0 |
| March September (E) Bid | +1 | 0 | −1 |
| March June September (B) Bid | +1 | −2 | +1 |

Prices can be implied from the Mar Ask into both sides of the Sep market. Firstly the outright markets and Butterfly can imply into the Sep bid as follows:

| | March | June | September |
|---|---|---|---|
| March Ask | −1 | 0 | 0 |
| June Bid (2) | 0 | +2 | 0 |
| March June September (B) Bid | +1 | −2 | +1 |
| September Bid | 0 | 0 | +1 |

Secondly the Mar Ask and Mar Sep Calendar spread can imply into the Sep Ask as follows:

| | March | June | September |
|---|---|---|---|
| March Ask | −1 | 0 | 0 |
| March September (E) Bid | +1 | 0 | −1 |
| September Ask | 0 | 0 | −1 |

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, although the preferred embodiments described above relate primarily to futures, options may also be used as a financial instrument for the types of combinations, matches, and trades encompassed by the present invention. The scope of the following claims is to be accorded the broadest interpretation so as to encompass all such modifications and equivalent structures and functions.

What is claimed is:

1. A method of facilitating trades relating to futures contracts, the method comprising the steps of:
receiving a plurality of orders, each of the plurality of orders being selected from the group consisting of a bid for an outright month futures contract, a bid for a predetermined combination of outright month futures contracts known as a futures strategy, an offer for an outright month futures contract, and an offer for a futures strategy;
using a computer to match corresponding orders from within the received plurality of orders; and
using a computer to electronically execute trades corresponding to the matched orders.

2. The method of claim 1, further comprising the step of combining at least two orders selected from the group consisting of a bid for an outright month futures contract and an offer for an outright month futures contract to form a combination order, and wherein the step of using a computer to match further comprises using a computer to match the combination order with at least one order selected from the group consisting of a bid for a futures strategy and an offer for a futures strategy.

3. The method of claim 1, further comprising the step of combining at least one order selected from the group consisting of a bid for an outright month futures contract and an offer for an outright month futures contract with at least one order selected from the group consisting of a bid for a futures strategy and an offer for a futures strategy to form a combination order, and wherein the step of using a computer to match further comprises using a computer to match the combination order with at least one order selected from the group consisting of a bid for an outright month futures contract and an offer for an outright month futures contract.

4. The method of claim 1, further comprising the step of combining at least two orders selected from the group consisting of a bid for a futures strategy and an offer for a futures strategy to form a combination order, and wherein the step of using a computer to match further comprises using a computer to match the combination order with at least one order selected from the group consisting of a bid for a futures strategy and an offer for a futures strategy.

5. The method of claim 1, further comprising the step of combining at least one order selected from the group consisting of a bid for an outright month futures contract and an offer for an outright month futures contract with at least one order selected from the group consisting of a bid for a futures strategy and an offer for a futures strategy to form a combination order, and wherein the step of using a computer to match further comprises using a computer to match the combination order with at least one order selected from the group consisting of a bid for a futures strategy and an offer for a futures strategy.

6. The method of claim 1, wherein the step of using a computer to match further comprises using a computer to match at least a first order and a second order for which a sum of leg ratios of all constituent outright month futures contracts is equal to zero.

7. The method of claim 1, the method further comprising the step of receiving a list of supported types of combinations provided by an operator, wherein the step of using a computer to match further comprises the step of using a computer to match corresponding orders from within the received plurality of orders such that the matched orders form a combination that is included on the list of supported types of combinations.

8. A system for facilitating trading of futures contracts, the system comprising:
a server at which the futures contracts are actively traded; and
an interface in communication with the server, the interface being configured to enable at least one order for a futures contract to be entered,
wherein the server is configured to receive a plurality of orders via the interface, each order including a price and a number of lots, and each of the plurality of orders being selected from the group consisting of a bid for an outright month futures contract, a bid for a predetermined combination of outright month futures contracts known as a futures strategy, an offer for an outright month futures contract, and an offer for a futures strategy; and
wherein the server is further configured to match corresponding orders from within the received plurality of orders, and to electronically execute trades corresponding to the matched orders.

9. The system of claim 8, wherein the server is further configured to combine at least two orders selected from the group consisting of a bid for an outright month futures contract and an offer for an outright month futures contract to form a combination order, and to match the combination order with at least one order selected from the group consisting of a bid for a futures strategy and an offer for a futures strategy.

10. The system of claim 8, wherein the server is further configured to combine at least one order selected from the group consisting of a bid for an outright month futures contract and an offer for an outright month futures contract with at least one order selected from the group consisting of a bid for a futures strategy and an offer for a futures strategy to form a combination order, and to match the combination order with at least one order selected from the group consisting of a bid for an outright month futures contract and an offer for an outright month futures contract.

11. The system of claim 8, wherein the server is further configured to combine at least two orders selected from the group consisting of a bid for a futures strategy and an offer for a futures strategy to form a combination order, and to match the combination order with at least one order selected from the group consisting of a bid for a futures strategy and an offer for a futures strategy.

12. The system of claim 8, wherein the server is further configured to combine at least one order selected from the group consisting of a bid for an outright month futures contract and an offer for an outright month futures contract with at least one order selected from the group consisting of a bid for a futures strategy and an offer for a futures strategy to form a combination order, and to match the combination order with at least one order selected from the group consisting of a bid for a futures strategy and an offer for a futures strategy.

13. The system of claim 8, wherein the server is further configured to match at least a first order and a second order for which a sum of leg ratios of all constituent outright month futures contracts is equal to zero.

14. The system of claim 8, the server being further configured to receive a list of supported types of combinations provided by an operator, and to match corresponding orders from within the received plurality of orders such that the matched orders form a combination that is included on the list of supported types of combinations.
